(19) United States
(12) Patent Application Publication
(10) Pub. No.: US 2006/0080351 A1
(43) Pub. Date: Apr. 13, 2006

(54) Super distribution of midlet suites

(75) Inventors: Matthew Powell, Perth (AU); Guido Cugi, Helsinki (FI); Alexander Davydov, Tampere (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/084,512

(22) Filed: Mar. 21, 2005

Related U.S. Application Data
(60) Provisional application No. 60/617,207, filed on Oct. 12, 2004.

(51) Int. Cl. G06F 7/00

(52) U.S. Cl. 707/102

(57) ABSTRACT

A MIDlet Suite comprising one or more encrypted installation files is determined at a sending terminal device. A distribution description file comprising Super Distribution identification information for the MIDlet Suite is generated. A non-encrypted distribution archive file comprising the distribution description file and the MIDlet Suite is generated. The distribution archive file is transmitted to a receiving terminal device. The distribution description file is extracted and the extracted distribution description file is parsed in order to obtain the Super Distribution identification information. The MIDlet Suite is extracted from the distribution archive file, and installation information is displayed. Thus the receiving device is able to verify the contents of a received MIDlet Suite before the acquisition of an associated Rights Object, and the user can make a more informed decision whether to acquire the associated Rights Object or not.

### REFERENCE TO RELATED APPLICATIONS

This application claims priority of U.S. Provisional Patent Application Ser. No. 60/617,207 filed on Oct. 12, 2004. The subject matter of this earlier filed provisional application is hereby incorporated by reference.

### BACKGROUND OF THE INVENTION

1. Field of the Invention

The invention relates to Java applications and Digital Rights Management. In particular, the invention relates to Super Distribution of MIDlet Suites.

2. Description of the Related Art

More and more terminal devices today include a Java platform to allow running of Java applications. One of these Java platforms is Java 2 Platform, Micro Edition (J2ME). The J2ME is targeted particularly at consumer electronics and embedded devices, such as mobile phones, pagers, personal digital assistants and set-top boxes.

Two specifications included in the J2ME are a Connected, Limited Device Configuration (CLDC) specification and a Mobile Information Device Profile (MIDP) specification. The CLDC specification outlines a basic set of libraries and virtual machine features that must be present in each implementation of a J2ME environment on resource-constrained devices. The MIDP specification is a specification that provides a core set of libraries for writing Java applications targeted for mobile devices. A profile defines the libraries that are used by developers to write applications for a specific device or for range of devices. For example, MIDP defines classes for creating user interfaces (e.g. textboxes, forms etc), handling user input, and communicating over a network with Hypertext Transfer Protocol (HTTP).

A Java application that conforms to the MIDP and CLDC specifications is called a MIDlet. Therefore, MIDlets are typically targeted at mobile devices that provide some level of network connectivity. The devices that will run MIDlets typically also have several common attributes: limited screen size, memory and processing power. The MIDP and CLDC specifications are designed to address these constraints.

MIDlets are often packaged and distributed as MIDlet Suites. The MIDlet Suite is a set of MIDlets plus resource files that may be required by these MIDlets. A MIDlet Suite comprises at least a Java Archive (JAR) file and, optionally, a Java Application Descriptor (JAD) file. The Java Archive file comprises one or more Java class files, and a manifest file describing the contents of the Java Archive file. The Java Archive file may further comprise resources, such as e.g. images and application data.

The manifest file included in the Java Archive file is typically a text file containing various attributes related to the MIDlet Suite, such as a name of the MIDlet Suite, a version number of the MIDlet Suite, a vendor name of the MIDlet Suite, a J2ME Profile required by the MIDlet Suite, and a J2ME Configuration required by the MIDlet Suite.

The optional Java Application Descriptor file is typically a text file containing information about the MIDlet Suite, such as name, Java Archive file size, version number, Micro Edition profile name and version etc. The Java Application Descriptor file allows an Application Management Software (AMS) to ensure that the associated MIDlet Suite is suitable for the device before loading the MIDlet Java Archive file. Additionally the Java Application Descriptor file allows the Application Management Software to perform simple version control. The term Application Management Software refers to a software program on the target device which is responsible for installing, running, and removing MIDlets Suites from the device. It also provides error-handling support. The Application Management Software may also provide an optional user interface that allows users to start, stop, and delete MIDlets.

While the arrangement for distributing and installing MIDlet Suites disclosed above works well enough in some cases, severe problems arise when Digital Rights Management, and Super Distribution in particular, are introduced.

Digital Rights Management (DRM) is a general term for standards and proprietary systems aimed at copyright protection where a given content item is augmented with information specifying usage rights associated with it. The content item may be e.g. an audio recording, video, picture, computer program or a document. The usage rights may comprise various rules pertaining to the use of the content item. For example, a user may be given a time limit during which the content item can be presented, in other words, rendered to the user. Allowed number of listening times and partial viewing rights are other examples of rules pertaining to the use of a content item. Digital Rights Management requires the presentation device and the presentation software in it not to be hostile, i.e. the presentation device and the presentation software are required to participate in the enforcement of digital rights. To allow this, there is usually a Digital Rights Management agent in the presentation device, or in other words, a Digital Rights Management engine, which enforces the Digital Rights Management rights and protects the content items from illicit use and copying. In order to avoid making a Digital Rights Management protected content item available for copying, the content item is sometimes encrypted while in transit to the presentation device and while stored in the presentation device, for example, on a hard disk.

One standard for Digital Rights Management is based on Open Mobile Alliance (OMA) Digital Rights Management specification. The object of the Open Mobile Alliance Digital Rights Management is to enable controlled consumption of digital media objects by allowing content providers to express content rights. The media objects are content items such as audio clips, video clips, pictures, Java applications and documents. Content rights are expressed as a Rights Object (RO) which is a document written using the Rights Expression Language (REL). In order to specify the rights pertaining to a content item a Rights Object is associated with the content item.

Super Distribution refers to a distribution method of OMA Digital Rights Management protected content items in which the content items and their associated Rights Objects are distributed separately. A first user may download a content item, e.g. an audio clip or an application from a website. The content item will be Digital Rights Management protected, i.e. encrypted. An associated Rights Object or Objects may be acquired separately, e.g. purchased and subsequently downloaded from a network server, by the first user in order to decrypt the content item and to allow access to it.

In a contrast to conventional distribution methods, however, the first user is allowed, and even encouraged, to send copies of the downloaded and still protected content item further on to a group of second users, e.g. friends and colleagues. The Rights Object, if acquired by the first user, cannot, however, be forwarded. Thus, the second users receiving the content item may in turn acquire a Rights Object of their own if they so desire. And, of course, the second users may send copies of the content item further on to third users, and so on.

Thus, OMA Super Distribution facilitates distribution and sales of content items by encouraging consumers to share the content items with other consumers.

As mentioned above, there are, however, some significant problems when Super Distribution is utilized for distribution of MIDlet Suites.

Since OMA Super Distribution requires content items to be OMA DRM protected, it follows that at least the Java Archive file of a MIDlet Suite received on a terminal device via OMA Super Distribution will be encrypted. The Java Archive file will be decrypted only after the user of the terminal device has purchased an associated Rights Object and downloaded it to the terminal device. Thus the terminal device receiving the MIDlet Suite has no way of verifying what it is receiving until after the acquisition of the Rights Object. In other words, the user must pay for content before knowing for certain what the content is.

Not being able to verify the received files is particularly problematic in case of MIDlet Suites. Firstly, not each and every MIDlet is necessarily compatible with every terminal device. As is known in the art, various terminal devices may implement various versions of MIDP and CLDC specifications, and these versions might differ from those of a downloaded MIDlet. Further, the downloaded MIDlet might require more persistent memory than the receiving device can provide, or the MIDlet might not be suitable for running on the receiving device for some other reason.

Furthermore, a MIDlet Suite may comprise a Java Application Descriptor file and a Java Archive file and obviously a user may receive several separate MIDlet Suites to a terminal device. Matching all these multiple received files to their respective MIDlet Suites requires complex logic and thus a significant amount of resources. Furthermore, this matching is made altogether impossible if the received files are encrypted, as is the case with OMA Super Distribution.

Furthermore, bad user experience may result as a consequence of sending the suite as two separate files, i.e. as a Java Application Descriptor file and a Java Archive file. The user may be confused to receive two files that are actually just one application. The confusion is furthered by the fact that some suites will only have a Java Archive file, while others will have both a Java Application Descriptor file and a Java Archive file.

Therefore, the object of the present invention is to alleviate the problems described above and to introduce Super Distribution of MIDlet Suites.

### SUMMARY OF THE INVENTION

A first aspect of the present invention is a method of Super Distribution of MIDlet Suites. A MIDlet Suite comprising one or more encrypted installation files is determined at a sending terminal device. In an embodiment the encrypted installation files include a Java Archive file comprising one or more Java class files, a manifest file describing the contents of the Java Archive file, and optionally resource files. The MIDlet Suite may further comprise a Java Application Descriptor file comprising installation information for the MIDlet Suite. The Java Application Descriptor file may not be encrypted. In an embodiment, if the MIDlet Suite does not have a Java Application Descriptor file, it may be created based on the MIDlet Suite's manifest file. A distribution description file which comprises Super Distribution identification information for the MIDlet Suite, is generated at the sending terminal device. Then, a non-encrypted distribution archive file which comprises the generated distribution description file and the MIDlet Suite files, i.e. the Java Application Descriptor file and the Java Archive file, is generated at the sending terminal device. The distribution archive file is transmitted from the sending terminal device to a receiving terminal device. The distribution description file is extracted from the received distribution archive file at the receiving terminal device. The extracted distribution description file is parsed in order to obtain the Super Distribution identification information contained therein. The MIDlet Suite is extracted from the received distribution archive file, and the installation information contained in the Java Application Descriptor file is displayed on the receiving terminal device.

A second aspect of the present invention is a method of Super Distribution of MIDlet Suites in which a MIDlet Suite comprising one or more encrypted installation files is determined at a sending terminal device, a distribution description file comprising Super Distribution identification information for the MIDlet Suite is generated, and a non-encrypted distribution archive file comprising the distribution description file and the MIDlet Suite is generated.

A third aspect of the present invention is a sending terminal device for Super Distribution of MIDlet Suites. The sending terminal device comprises a determinator for determining a MIDlet Suite comprising one or more encrypted installation files. The sending terminal device further comprises a first generator for generating a distribution description file comprising Super Distribution identification information for the MIDlet Suite. The sending terminal device further comprises a second generator for generating a non-encrypted distribution archive file comprising the generated distribution description file and the MIDlet Suite files. The sending terminal device further comprises a transmitter for sending the generated distribution archive file to a receiving terminal device.

A fourth aspect of the present invention is a receiving terminal device for Super Distribution of MIDlet Suites. The receiving terminal device comprises a receiver for receiving a distribution archive file comprising a MIDlet Suite comprising one or more encrypted installation files which distribution archive file further comprises a distribution description file comprising Super Distribution identification information for the MIDlet Suite. The receiving terminal device further comprises a first extractor for extracting the distribution description file from the received distribution archive file. The receiving terminal device further comprises a parser for parsing the extracted distribution description file in order to obtain the Super Distribution identification information contained therein. The receiving terminal device further comprises a second extractor for extracting the MIDlet Suite from the received distribution archive file. The receiving terminal device further comprises a display for displaying installation information contained in a Java Application Descriptor file included in the received MIDlet Suite.

A fifth aspect of the present invention is a computer program product for Super Distribution of MIDlet Suites. The computer program product is embodied on at least one computer readable medium, and the computer program product executes a computer process comprising: determining, at a sending terminal device, a MIDlet Suite comprising one or more encrypted installation files, generating a distribution description file comprising Super Distribution identification information for the MIDlet Suite, generating a non-encrypted distribution archive file comprising the distribution description file and the MIDlet Suite, transmitting the distribution archive file from the sending terminal device to a receiving terminal device, extracting, at the receiving terminal device, the distribution description file from the received distribution archive file, parsing the extracted distribution description file in order to obtain the Super Distribution identification information contained therein, extracting the MIDlet Suite from the received distribution archive file, and displaying installation information contained in a Java Application Descriptor file included in the received MIDlet Suite on the receiving terminal device.

A sixth aspect of the present invention is a computer program product for Super Distribution of MIDlet Suites. The computer program product is embodied on at least one computer readable medium, and the computer program product executes a computer process comprising: determining, at a sending terminal device, a MIDlet Suite comprising one or more encrypted installation files, generating a distribution description file comprising Super Distribution identification information for the MIDlet Suite, generating a non-encrypted distribution archive file comprising the distribution description file and the MIDlet Suite, and transmitting the distribution archive file from the sending terminal device to a receiving terminal device.

A seventh aspect of the present invention is a computer program product for Super Distribution of MIDlet Suites. The computer program product is embodied on at least one computer readable medium, and the computer program product executes a computer process comprising: extracting, from a received distribution archive file comprising a MIDlet Suite comprising one or more encrypted installation files and the distribution archive file further comprising a distribution description file comprising Super Distribution identification information for the MIDlet Suite, the distribution description file at a receiving terminal device, parsing the extracted distribution description file in order to obtain the Super Distribution identification information contained therein, extracting the MIDlet Suite from the received distribution archive file, and displaying on the receiving terminal device installation information contained in a Java Application Descriptor file included in the MIDlet Suite.

An eighth aspect of the present invention is a system for Super Distribution of MIDlet Suites. The system comprises a sending terminal device and a receiving terminal device. The sending terminal device comprises a determinator for determining a MIDlet Suite comprising one or more encrypted installation files. The sending terminal device further comprises a first generator for generating a distribution description file comprising Super Distribution identification information for the MIDlet Suite. The sending terminal device further comprises a second generator for generating a non-encrypted distribution archive file comprising the generated distribution description file and the MIDlet Suite files. The sending terminal device further comprises a transmitter for sending the generated distribution archive file to the receiving terminal device. The receiving terminal device comprises a receiver for receiving the distribution archive file from the sending terminal device. The receiving terminal device further comprises a first extractor for extracting the distribution description file from the received distribution archive file. The receiving terminal device further comprises a parser for parsing the extracted distribution description file in order to obtain the Super Distribution identification information contained therein. The receiving terminal device further comprises a second extractor for extracting the MIDlet Suite from the received distribution archive file. The receiving terminal device further comprises a display for displaying installation information contained in a Java Application Descriptor file included in the received MIDlet Suite.

A ninth aspect of the present invention is a computer program for Super Distribution of MIDlet Suites. The computer program is embodied on at least one computer readable medium, and the computer program executes a computer process comprising: determining, at a sending terminal device, a MIDlet Suite comprising one or more encrypted installation files, generating a distribution description file comprising Super Distribution identification information for the MIDlet Suite, generating a non-encrypted distribution archive file comprising the distribution description file and the MIDlet Suite, transmitting the distribution archive file from the sending terminal device to a receiving terminal device, extracting, at the receiving terminal device, the distribution description file from the received distribution archive file, parsing the extracted distribution description file in order to obtain the Super Distribution identification information contained therein, extracting the MIDlet Suite from the received distribution archive file, and displaying installation information contained in a Java Application Descriptor file included in the received MIDlet Suite on the receiving terminal device.

A tenth aspect of the present invention is a computer program for Super Distribution of MIDlet Suites. The computer program is embodied on at least one computer readable medium, and the computer program executes a computer process comprising: determining, at a sending terminal device, a MIDlet Suite comprising one or more encrypted installation files, generating a distribution description file comprising Super Distribution identification information for the MIDlet Suite, generating a non-encrypted distribution archive file comprising the distribution description file and the MIDlet Suite, and transmitting the distribution archive file from the sending terminal device to a receiving terminal device.

An eleventh aspect of the present invention is a computer program for Super Distribution of MIDlet Suites. The computer program is embodied on at least one computer readable medium, and the computer program executes a computer process comprising: extracting, from a received distribution archive file comprising a MIDlet Suite comprising one or more encrypted installation files and the distribution archive file further comprising a distribution description file comprising Super Distribution identification information for the MIDlet Suite, the distribution description file at a receiving terminal device, parsing the extracted distribution description file in order to obtain the Super Distribution identification information contained therein, extracting the MIDlet Suite from the received distribution archive file, and displaying on the receiving terminal device installation information contained in a Java Application Descriptor file included in the MIDlet Suite.

In an embodiment of the invention the MIDlet Suite further comprises a Uniform Resource Identifier for an associated Rights Object, and the associated Rights Object is downloaded by utilizing the Uniform Resource Identifier.

In an embodiment of the invention the generated non-encrypted distribution archive file is a Java Archive file.

In an embodiment of the invention the sending terminal device is a mobile telecommunication terminal device. In an embodiment of the invention the receiving terminal device is a mobile telecommunication terminal device.

In an embodiment the sending terminal device is configured to generate a Java Application Descriptor file to be included in said non-encrypted distribution archive file.

In an embodiment of the invention the at least one computer readable medium is a magnetic or optical disk.

In an embodiment of the invention the at least one computer readable medium is a read-only memory circuit.

The present invention allows Super Distribution of MIDlet Suites in such a way that the receiving device is able to verify contents of a received MIDlet Suite before the acquisition of an associated Rights Object. As a consequence, the user of the receiving device can make a more informed decision whether to acquire the associated Rights Object or not. At the same time, the present invention retains normal MIDP security since the Java Application Descriptor and Java Archive files will be checked and any signatures verified once the Rights Object has arrived.

Further, having a single distribution archive file instead of various separate files during transport alleviates prior art complexities of having to match multiple files to a single installation.

Further, having a single distribution archive file instead of various separate files during transport improves user experience as the whole MIDlet Suite is received as a single file.

Further, having a MIDlet Suite's Java Application Descriptor file sent together with the Java Archive file makes it more unlikely that information containing in the Java Application Descriptor file required by the MIDlet is lost.

Further, the distribution archive file of the present invention can be copied or sent via any medium regardless of whether a Multi-Purpose Internet Mail Extensions (MIME) type can be associated with it or not. The distribution archive file of the present invention is self-contained. Due to Super Distribution identification information contained in the distribution description file of the present invention, the distribution archive file is easily identifiable as a Super Distributed MIDlet Suite even if it is copied into an installation directory manually.

Further, the present invention requires no infrastructure changes in delivery servers, peer-to-peer protocols or intermediate software in the terminals.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a graphical representation illustrating a method according to an embodiment of the present invention,

FIG. 2a is a block diagram illustrating a sending terminal device according to an embodiment of the present invention, and

FIG. 2b is a block diagram illustrating a receiving terminal device according to an embodiment of the present invention.

### DETAILED DESCRIPTION OF THE INVENTION

Reference will now be made in detail to the embodiments of the invention, examples of which are illustrated in the accompanying drawings.

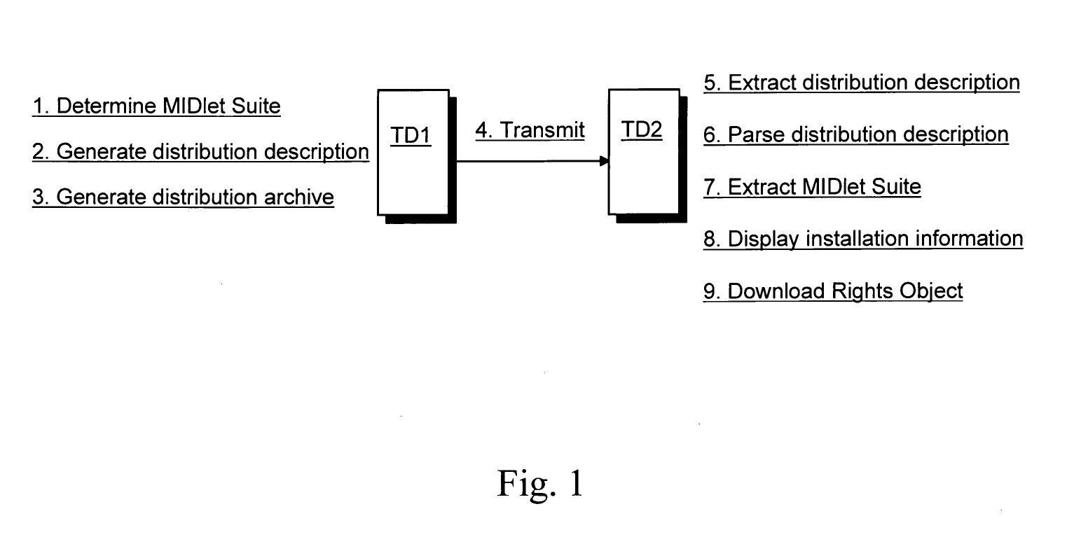

FIG. 1 illustrates an exemplary embodiment of the method of the present invention relating to Super Distribution of MIDlet Suites.

At step 1 a MIDlet Suite comprising one or more encrypted installation files is determined at a sending terminal device TD1. The user of the sending terminal device TD1 may e.g. decide to forward a MIDlet Suite to a friend. Therefore, the one or more encrypted installation files which form the MIDlet Suite to be forwarded, are determined.

At step 2 a distribution description file which comprises Super Distribution identification information, is generated at the sending terminal device TD1. If the MIDlet suite does not contain a Java Application Descriptor file, it may also be generated based on the content of the manifest file.

The distribution description file may be e.g. a text file. The Super Distribution identification information may be e.g. a tag which designates the distribution archive file containing the tag as a Super Distributable archive file. In other words, by means of the tag a receiving device will be able to identify the distribution archive file to be a Super Distributable archive file. The MIDlet Suite comprises a Java Application Descriptor file comprising installation information including e.g. a name of the MIDlet Suite, a version number of the MIDlet Suite, a vendor name of the MIDlet Suite, and file size of the Java Archive file included in the MIDlet Suite and containing the Java class files.

Next, at step 3, a non-encrypted distribution archive file which comprises the generated distribution description file and the MIDlet Suite files, is generated at the sending terminal device TD1. The generated distribution archive file may be e.g. a Java Archive file. Since the generated distribution archive file is not encrypted, the distribution description file in it can be read at the receiving device without having to acquire the associated Rights Object. Yet, at the same time those MIDlet Suite files in the distribution archive file that are encrypted will remain encrypted. The distribution archive file is transmitted from the sending terminal device TD1 to a receiving terminal device TD2, step 4.

Then, at step 5, the distribution description file is extracted from the received distribution archive file at the receiving terminal device TD2. The extracted distribution description file is parsed in order to obtain the Super Distribution identification information contained therein, step 6. At step 7, the MIDlet Suite files are extracted from the received distribution archive file. Then, the installation information is displayed on the receiving terminal device TD2, step 8. At optional step 9, the associated Rights Object is downloaded by utilizing a Uniform Resource Identifier included in the MIDlet Suite.

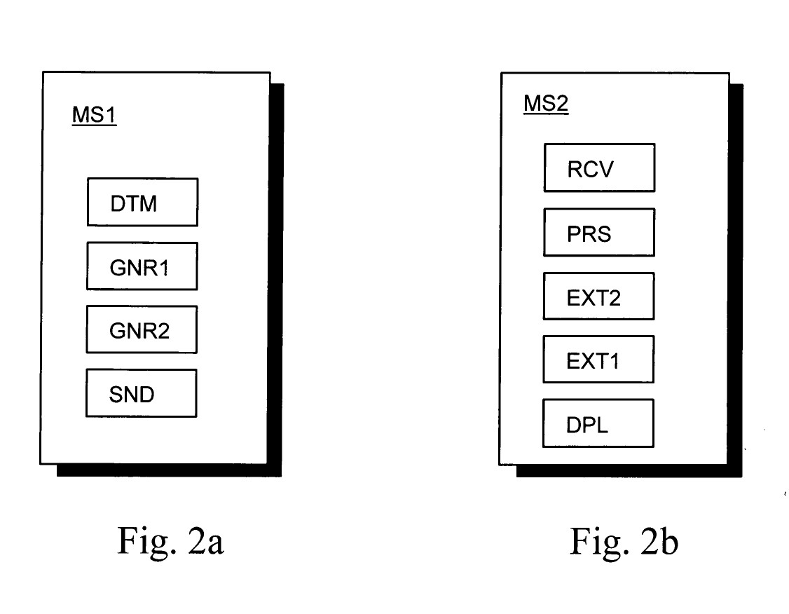

FIG. 2a illustrates an exemplary embodiment of the sending terminal device of the present invention relating to Super Distribution of MIDlet Suites. The sending terminal device is a mobile telecommunication terminal device MS1 in the exemplary embodiment of FIG. 2a.

The sending terminal device MS1 comprises a determinator DTM for determining a MIDlet Suite comprising one or more encrypted installation files. The sending terminal device MS1 further comprises a first generator GNR1 for generating a distribution description file comprising Super Distribution identification information for the MIDlet Suite. If the MIDlet suite does not already contain a Java Application Descriptor file, it may also be generated based on the content of the manifest file.

The sending terminal device MS1 further comprises a second generator GNR2 for generating a non-encrypted distribution archive file comprising the generated distribution description file and the MIDlet Suite. The sending terminal device MS1 further comprises a transmitter SND for sending the generated distribution archive file to a receiving terminal device.

The determinator DTM, the first generator GNR1, the second generator GNR2 and the transmitter SND may be implemented in software, in hardware, or as a combination of software and hardware. In an embodiment, at least one of the determinator DTM, the first generator GNR1, the second generator GNR2 and the transmitter SND is integrated into an Application Management Software of the sending terminal device MS1.

FIG. 2b illustrates an exemplary embodiment of the receiving terminal device of the present invention relating to Super Distribution of MIDlet Suites. The receiving terminal device is a mobile telecommunication terminal device MS2 in the exemplary embodiment of FIG. 2b.

The receiving terminal device MS2 comprises a receiver RCV for receiving a distribution archive file comprising a MIDlet Suite comprising one or more encrypted installation files which distribution archive file further comprises a distribution description file comprising Super Distribution identification information for the MIDlet Suite. The receiving terminal device MS2 further comprises a first extractor EXT1 for extracting the distribution description file from the received distribution archive file. The receiving terminal device MS2 further comprises a parser PRS for parsing the extracted distribution description file in order to obtain the Super Distribution identification information contained therein. The receiving terminal device MS2 further comprises a second extractor EXT2 for extracting the MIDlet,Suite from the received distribution archive file. The receiving terminal device MS2 further comprises a display DPL for displaying installation information contained in a Java Application Descriptor file included in the MIDlet Suite.

The receiver RCV, the first extractor EXT1, the second extractor EXT2, the parser PRS and the display DPL may be implemented in software, in hardware, or as a combination of software and hardware. In an embodiment, at least one of the receiver RCV, the first extractor EXT1, the second extractor EXT2, the parser PRS and the display DPL is integrated into an Application Management Software of the receiving terminal device MS2.

It is obvious to a person skilled in the art that with the advancement of technology, the basic idea of the invention may be implemented in various ways. The invention and its embodiments are thus not limited to the examples described above, instead they may vary within the scope of the claims.

What is claimed is:

1. A method of Super Distribution of MIDlet Suites, the method comprising:
determining, at a sending terminal device, a MIDlet Suite comprising at least one encrypted installation file,
generating a distribution description file comprising Super Distribution identification information for said MIDlet Suite,
generating a non-encrypted distribution archive file comprising said distribution description file and said MIDlet Suite,
transmitting said non-encrypted distribution archive file from said sending terminal device to a receiving terminal device,
extracting, at said receiving terminal device, said distribution description file from said received non-encrypted distribution archive file,
parsing said extracted distribution description file in order to obtain said Super Distribution identification information contained therein,
extracting said MIDlet Suite from said received non-encrypted distribution archive file, and displaying, on said receiving terminal device, installation information contained in a Java Application Descriptor file included in said MIDlet Suite.

2. The method according to claim 1, wherein said step of determining comprises determining, at a sending terminal device, a MIDlet Suite further comprising a Uniform Resource Identifier for an associated Rights Object.

3. The method according to claim 2, further comprising:
downloading said associated Rights Object by utilizing said Uniform Resource Identifier.

4. The method according to claim 1, wherein said step of generating a non-encrypted distribution archive file comprises generating a Java Archive file.

5. The method according to claim 1, further comprising generating a Java Application Descriptor file to be included in said non-encrypted distribution archive file.

6. A method of Super Distribution of MIDlet Suites, the method comprising:
determining, at a sending terminal device, a MIDlet Suite comprising at least one encrypted installation file,
generating a distribution description file comprising Super Distribution identification information for said MIDlet Suite, and
generating a non-encrypted distribution archive file comprising said distribution description file and said MIDlet Suite.

7. The method according to claim 6, further comprising:
transmitting said non-encrypted distribution archive file from said sending terminal device to a receiving terminal device.

8. The method according to claim 7, further comprising:
extracting, at said receiving terminal device, said distribution description file from said received non-encrypted distribution archive file,
parsing said extracted distribution description file in order to obtain said Super Distribution identification information contained therein,
extracting said MIDlet Suite from said received non-encrypted distribution archive file, and displaying, on said receiving terminal device, installation information contained in a Java Application Descriptor file included in said MIDlet Suite.

9. The method according to claim 6, wherein said step of determining comprises determining, at a sending terminal device, a MIDlet Suite further comprising a Uniform Resource Identifier for an associated Rights Object.

10. The method according to claim 9, further comprising:
downloading said associated Rights Object by utilizing said Uniform Resource Identifier.

11. The method according to claim 6, wherein said step of generating a non-encrypted distribution archive file comprises generating a Java Archive file.

12. The method according to claim 6, further comprising generating a Java Application Descriptor file to be included in said non-encrypted distribution archive file.

13. A sending terminal device for Super Distribution of MIDlet Suites, said sending terminal device comprising:
a determinator for determining a MIDlet Suite comprising at least one encrypted installation file,
a first generator for generating a distribution description file comprising Super Distribution identification information for said MIDlet Suite,
a second generator for generating a non-encrypted distribution archive file comprising said distribution description file and said MIDlet Suite, and
a transmitter for sending said non-encrypted distribution archive file to a receiving terminal device.

14. The sending terminal device according to claim 13, wherein said sending terminal device is a mobile telecommunication terminal device.

15. The sending terminal device according to claim 13, further configured to generate a Java Application Descriptor file to be included in said non-encrypted distribution archive file.

16. A receiving terminal device for Super Distribution of MIDlet Suites, said receiving terminal device comprising:
a receiver for receiving a distribution archive file comprising a MIDlet Suite comprising at least one encrypted installation file, said distribution archive file further comprising a distribution description file comprising Super Distribution identification information for said MIDlet Suite,
a first extractor for extracting said distribution description file from said received distribution archive file,
a parser for parsing said extracted distribution description file in order to obtain said Super Distribution identification information contained therein,
a second extractor for extracting said MIDlet Suite from said received distribution archive file, and
a display for displaying installation information contained in a Java Application Descriptor file included in said MIDlet Suite.

17. The receiving terminal device according to claim 16, wherein said receiving terminal device is a mobile telecommunication terminal device.

18. A system for Super Distribution of MIDlet Suites, said system comprising:
a sending terminal device comprising
a determinator for determining a MIDlet Suite comprising at least one encrypted installation file,
a first generator for generating a distribution description file comprising Super Distribution identification information for said MIDlet Suite,
a second generator for generating a non-encrypted distribution archive file comprising said distribution description file and said MIDlet Suite, and
a transmitter for sending said non-encrypted distribution archive file to the receiving terminal device, and
a receiving terminal device comprising a receiver for receiving said non-encrypted distribution archive file from the sending terminal device,
a first extractor for extracting said distribution description file from said received non-encrypted distribution archive file,
a parser for parsing said extracted distribution description file in order to obtain said Super Distribution identification information contained therein,
a second extractor for extracting said MIDlet Suite from said received non-encrypted distribution archive file, and
a display for displaying installation information contained in a Java Application Descriptor file included in said MIDlet Suite.

19. The system according to claim 18, wherein said sending terminal device is further configured to generate a Java Application Descriptor file to be included in said non-encrypted distribution archive file.

20. A computer program product for Super Distribution of MIDlet Suites, embodied on at least one computer readable medium, said computer program product executing a computer process comprising:
determining, at a sending terminal device, a MIDlet Suite comprising at least one encrypted installation file,
generating a distribution description file comprising Super Distribution identification information for said MIDlet Suite,
generating a non-encrypted distribution archive file comprising said distribution description file and said MIDlet Suite,
transmitting said non-encrypted distribution archive file from said sending terminal device to a receiving terminal device,
extracting, at said receiving terminal device, said distribution description file from said received non-encrypted distribution archive file,
parsing said extracted distribution description file in order to obtain said Super Distribution identification information contained therein,
extracting said MIDlet Suite from said received non-encrypted distribution archive file, and displaying on said receiving terminal device installation information contained in a Java Application Descriptor file included in said MIDlet Suite.

21. The computer program product according to claim 20, wherein said at least one computer readable medium is a magnetic or optical disk.

22. The computer program product according to claim 20, wherein said at least one computer readable medium is a read-only memory circuit.

23. The computer program product according to claim 20, wherein said computer process further comprises generating a Java Application Descriptor file to be included in said non-encrypted distribution archive file.

24. A computer program product for Super Distribution of MIDlet Suites, embodied on at least one computer readable medium, said computer program product executing a computer process comprising:
determining, at a sending terminal device, a MIDlet Suite comprising at least one encrypted installation file,
generating a distribution description file comprising Super Distribution identification information for said MIDlet Suite,
generating a non-encrypted distribution archive file comprising said distribution description file and said MIDlet Suite, and
transmitting said non-encrypted distribution archive file from said sending terminal device to a receiving terminal device.

25. A computer program product for Super Distribution of MIDlet Suites, embodied on at least one computer readable medium, said computer program product executing a computer process comprising:
extracting, from a received distribution archive file comprising a MIDlet Suite comprising at least one encrypted installation file and said distribution archive file further comprising a distribution description file comprising Super Distribution identification information for said MIDlet Suite, said distribution description file at a receiving terminal device,
parsing said extracted distribution description file in order to obtain said Super Distribution identification information contained therein,
extracting said MIDlet Suite from said received distribution archive file, and
displaying on said receiving terminal device installation information contained in a Java Application Descriptor file included in said MIDlet Suite.

26. A computer program for Super Distribution of MIDlet Suites, embodied on at least one computer readable medium, said computer program executing a computer process comprising:
determining, at a sending terminal device, a MIDlet Suite comprising at least one encrypted installation file,
generating a distribution description file comprising Super Distribution identification information for said MIDlet Suite,
generating a non-encrypted distribution archive file comprising said distribution description file and said MIDlet Suite,
transmitting said non-encrypted distribution archive file from said sending terminal device to a receiving terminal device,
extracting, at said receiving terminal device, said distribution description file from said received non-encrypted distribution archive file,
parsing said extracted distribution description file in order to obtain said Super Distribution identification information contained therein,
extracting said MIDlet Suite from said received non-encrypted distribution archive file, and displaying on said receiving terminal device installation information contained in a Java Application Descriptor file included in said MIDlet Suite.

27. The computer program according to claim 26, wherein said computer process further comprises generating a Java Application Descriptor file to be included in said non-encrypted distribution archive file.

28. A computer program for Super Distribution of MIDlet Suites, embodied on at least one computer readable medium, said computer program executing a computer process comprising:
determining, at a sending terminal device, a MIDlet Suite comprising at least one encrypted installation file,
generating a distribution description file comprising Super Distribution identification information for said MIDlet Suite,
generating a non-encrypted distribution archive file comprising said distribution description file and said MIDlet Suite, and
transmitting said non-encrypted distribution archive file from said sending terminal device to a receiving terminal device.

29. A computer program for Super Distribution of MIDlet Suites, embodied on at least one computer readable medium, said computer program executing a computer process comprising:
extracting, from a received distribution archive file comprising a MIDlet Suite comprising one or more encrypted installation files and said distribution archive file further comprising a distribution description file comprising Super Distribution identification information for said MIDlet Suite, said distribution description file at a receiving terminal device,
parsing said extracted distribution description file in order to obtain said Super Distribution identification information contained therein,
extracting said MIDlet Suite from said received distribution archive file, and
displaying on said receiving terminal device installation information contained in a Java Application Descriptor file included in said MIDlet Suite.

30. A receiving terminal device for Super Distribution of MIDlet Suites, said receiving terminal device comprising:
receiving means for receiving a distribution archive file comprising a MIDlet Suite comprising at least one encrypted installation file, said distribution archive file further comprising a distribution description file comprising Super Distribution identification information for said MIDlet Suite,
first extracting means for extracting said distribution description file from said received distribution archive file,
parsing means for parsing said extracted distribution description file in order to obtain said Super Distribution identification information contained therein,
second extracting means for extracting said MIDlet Suite from said received distribution archive file, and
display means for displaying installation information contained in a Java Application Descriptor file included in said MIDlet Suite.
